(19) United States
(12) Patent Application Publication
(10) Pub. No.: US 2006/0134388 A1
(43) Pub. Date: Jun. 22, 2006

(54) Heavy calendered multiple component sheets and multi-layer laminates and packages therefrom

(76) Inventors: Mark Ralph Miller, Newark, DE (US); Edgar N. Rudisill, Nashville, TN (US); Edith Gottemoller Triplett, Midlothian, VA (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/019,578

(22) Filed: Dec. 22, 2004

(51) Int. Cl. B32B 1/00

(52) U.S. Cl. 428/174

(57) ABSTRACT

A heavily calendered multiple component sheet is provided by calendering a multiple component nonwoven web formed from multiple component spunbond filaments under conditions that cause the lower-melting component to melt and flow into the interstitial spaces between the spunbond filaments. The calendered sheets are useful in child resistant packaging.

### BACKGROUND OF THE INVENTION

1. Field of the Invention

The present invention relates to heavily calendered sheet materials that are formed by calendering a multiple component nonwoven fabric comprising multiple component spunbond fibers under conditions that result in at least a portion of the lower-melting polymer component flowing into and at least partially filling the interstitial spaces between the fibers. The calendered sheets are especially suited for use in multi-layer laminates for the manufacture of child resistant blister packages.

2. Description of the Related Art

It is known in the art to thermally bond nonwoven webs by intermittent point or pattern bonding, or smooth calendering. Point or pattern bonding can be achieved by applying heat and pressure at discrete areas on the surface of the web, for example by passing the web through a heated nip formed by a patterned calender roll and a smooth roll, or between two patterned rolls. Intermittently bonded nonwovens are especially suitable for end uses where high permeability and comfort are desired, but they do not have sufficiently high strength or tear properties for certain end uses such as child-resistant packaging. In a smooth calendering process, a nonwoven web is thermally bonded by applying heat and pressure to the web in a nip formed between two smooth rolls, which bonds the web substantially uniformly across its surface.

Thermal bonding is generally conducted at temperatures approaching the melting point of the lowest melting polymer in the nonwoven web. Low calendering temperature, low calendering pressure and high line speed result in lower levels of thermal bonding than high calendering temperature, high calendering pressure and low line speed. The nonwoven web is generally heated to a high enough temperature for the fibers to become partially molten or flowable. When the web is cooled those fibers in sufficient proximity to contact one another become thermally bonded at their cross-over points as the temperature falls below the melting or glass transition point of the polymer.

U.S. Pat. No. 5,492,580 to Frank describes forming a fibrous batt of a blend first and second fibers wherein the second fibers have a melting point lower than that of the first fibers and heating the nonwoven structure at a temperature below the melting point of the first fibers and above the melting point of the second fibers to substantially liquefy the second fibers and form a thermoplastic resin. The heated nonwoven structure is compressed to flow the liquefied resin to displace air voids in the nonwoven structure and encapsulate the first fibers. The resulting composite material is described as a stiff fibrous panel suitable for thermoforming. Batts used to form the composite material are relatively heavy, with basis weights 300 g/m² or higher.

U.S. Pat. No. 4,766,029 to Brock et al. describes spunbond-meltblown-spunbond nonwoven laminates wherein the meltblown layer is a two-component (mixture) meltblown layer and the laminate is calendered such that the lower-melting component in the meltblown layer melts and flows to close up the interstitial space and bond the layers together.

U.S. Pat. No. 4,657,804 to Mays et al. describes a smooth-surfaced, gas-permeable bacterial barrier laminated material comprising a ply of hydrophobic microfine fibers thermally bonded to a layer of conjugate fibers having a low melting sheath and a high melting core. In the thermal bonding step, the lower-melting component of the conjugate fibers is at least partially fused so that where the fused surface touches another conjugate fiber, welding or fusing together of the two fibers occurs. Fusion bonding can be achieved by means of a conventional heated calender. The calendered products are described as being porous and are impregnated with a repellent binder and repellent finish in order to reduce the fabric surface energy and voids between the fibers. The laminates are described as being suitable for use as a lid for a polymer blister package.

Packages that include a substantially impermeable lidding component are known in the art, for example blister packages that are used for packaging pharmaceuticals and other materials. When used for packaging materials that are oxygen- and/or moisture-sensitive, the package should have sufficient barrier properties to ensure a reasonable shelf-life for the packaged materials. Blister packages include a blister component having at least one cavity formed therein into which the medicine or other packaged material is placed prior to being heat-sealed to a lidding component. Lidding components known in the art include films, and laminates comprising combinations of films, paper, and/or foil. When used for packaging pharmaceuticals or other materials that may be harmful to children, a blister package should also be child-resistant so that a child cannot open the package, bite through it, or otherwise damage the packaging in a way that exposes the packaged material.

One challenge in the manufacture of blister packaging is to make a package that is child resistant that can also be opened by an adult without undue difficulty. Certain child-resistant blister packages known in the art include peel-open packages that comprise a laminated paper-film lidding component adhered to a plastic blister component by a peelable sealant. Further child-resistance is obtained using a peel off-push through package. An example of a peel off-push through blister package is described in Brunda, U.S. Pat. No. 3,899,080. The blister package comprises a peelable outer layer, for example film, cardboard, or paper that is adhered by a peelable adhesive to a rupturable layer such as paper, selected plastics, or metal foil. Gerber published European Patent Application 0959020 describes a peel off-push through type blister package that includes a cover sheet containing a metal foil-free push-through penetrable plastic layer, a peelable release adhesive, and a non-penetrable cover layer. The cover layer is peeled off the release adhesive in a first step and the packaged material is pushed through the metal foil-free penetrable plastic layer.

One disadvantage of current peel off-push through packages is that paper-film-foil laminates used in the lidding do not generally peel cleanly in one piece and often tear at the perforation, making it difficult to initiate a new peel. Some paper-film laminates and paper-film-foil laminates also have poor puncture resistance and can be chewed through by a child.

There remains a need for an improved sheet product for use in child resistant packaging that is strong enough to prevent the package from being easily opened by tearing or puncturing while at the same time peeling cleanly from the package in one piece. In multi-blister packages, wherein perforated lines separate the individual blisters, it is also desirable that the sheet product tear cleanly at the perforations to enable removing individual blisters from the multi-blister package.

### BRIEF SUMMARY OF THE INVENTION

In a first embodiment, the present invention is directed to a heavily calendered multiple component spunbond sheet comprising continuous multiple component spunbond filaments, the multiple component filaments comprising between about 10 and 90 weight percent of a first lower-melting polymeric component and between about 90 and 10 weight percent of a second higher-melting polymeric component, the first polymeric component comprising at least a portion of the peripheral surface of the filaments, wherein interstitial spaces between the filaments are at least partially filled by the lower-melting component and are substantially free of separately added resin binder, said sheet having an Elmendorf tear measured in both the machine direction and the cross direction of between 0.5 lb and 6.0 lb, a Graves tear measured in both the machine direction and the cross direction of at least 4.0 lb, and a Spencer Puncture of at least 0.70 J.

A second embodiment of the present invention is a multi-layer laminate comprising the heavily calendered multiple component spunbond sheet described above, adhered to a second sheet layer.

Another embodiment of the present invention is a blister package comprising a blister component having an inner surface and an outer surface and a lidding component comprising the multi-layer laminate described above, the lidding component having an outer surface comprising the heavily calendered multiple component spunbond sheet and an inner surface comprising the heat seal layer, wherein selected portions of the inner surfaces of the blister and lidding components are adhered together by the heat-seal layer to form a continuous seal and at least one cavity therebetween, the blister component comprising a second barrier layer selected from the group consisting of polymeric films, coated polymeric films, metal foils, and film-foil laminates.

Another embodiment of the present invention is directed to a blister package comprising a blister component having an inner surface and an outer surface and a lidding component having an inner and outer surface, the lidding component comprising a multi-layer laminate of a spunbond/meltblown/spunbond fabric and a first barrier layer, wherein at least one of said spunbond layers is a heavily calendered multiple component spunbond sheet comprising continuous multiple component spunbond filaments, the multiple component filaments comprising between about 10 and 90 weight percent of a first lower-melting polymeric component and between about 90 and 10 weight percent of a second higher-melting polymeric component, the first polymeric component comprising at least a portion of the peripheral surface of the filaments, wherein interstitial spaces between the filaments are at least partially filled by the lower-melting component and are substantially free of separately added resin binder, said heavily calendered sheet having an Elmendorf tear measured in both the machine direction and the cross direction of between 0.5 lb and 6.0 lb, a Graves tear measured in both the machine direction and the cross direction of at least 4.0 lb, and a Spencer Puncture of at least 0.70 J, said second spunbond layer is a multicomponent spunbond sheet, said first barrier layer adhered to said second multiple component spunbond sheet, said first barrier layer is selected from the group consisting of polymeric films, metal foils, coated polymeric films, and metalized polymeric films, wherein selected portions of the inner surfaces of the blister and lidding components are adhered together to form a continuous seal and at least one cavity therebetween, the blister component comprising a second barrier layer selected from the group consisting of polymeric films, coated polymeric films, metal foils, and film-foil laminates, and wherein the outer surface of the lidding component comprises the heavily calendered multiple component sheet.

### BRIEF DESCRIPTION OF THE DRAWINGS

FIGS. 1A-1C are a schematic diagrams of calendering processes suitable for making the calendered sheets of the present invention.

FIG. 2 is a schematic elevation view of a blister package.

FIG. 3A is a schematic cross-sectional view of a lidding material useful in blister packages of the present invention.

FIG. 3B is a schematic cross-sectional view of a second embodiment of a lidding material useful in blister packages of the present invention.

FIG. 4 is a schematic diagram of a process suitable for preparing a blister package of the present invention.

FIG. 5 is a portion of the product made by the process of FIG. 4, showing a package comprising multiple blisters.

### DETAILED DESCRIPTION OF THE INVENTION

The present invention relates to smooth-calendered multiple component sheets that are formed by calendering a multiple component nonwoven fabric comprising fibers comprising a higher-melting component and a lower-melting component under conditions that result in at least a portion of the lower-melting polymer component flowing into and at least partially filling the interstitial spaces between the fibers. The degree of flowing of the lower-melting component is controlled to provide a calendered sheet having an improved combination of tear properties. No separately added binder is required in order to achieve desired properties. In one embodiment, the smooth-calendered sheet is laminated to a foil or film for use in child resistant packaging to provide laminates having an improved balance of tear properties and puncture resistance compared to paper-based foil and film laminates used in the art.

The term “polyethylene” (PE) as used herein is intended to encompass not only homopolymers of ethylene, but also copolymers wherein at least 85% of the recurring units are ethylene units, and includes “linear low density polyethylenes” (LLDPE) which are linear ethylene/α-olefin copolymers having a density of less than about 0.955 g/cm³, and “high density polyethylenes” (HDPE), which are polyethylene homopolymers having a density of at least about 0.94 g/cm³.

The term “polyester” as used herein is intended to embrace polymers wherein at least 85% of the recurring units are condensation products of dicarboxylic acids and dihydroxy alcohols with linkages created by formation of ester units. Examples of polyesters include poly(ethylene terephthalate) (PET), which is a condensation product of ethylene glycol and terephthalic acid, and poly(1,3-propylene terephthalate), which is a condensation product of 1,3-propanediol and terephthalic acid.

The term “barrier layer” as used herein refers to a sheet layer, including films and coatings that restrict the permeation of oxygen and/or water vapor into a blister package that comprises the sheet layer. Barrier layers suitable for use in the present invention preferably have a moisture vapor transmission rate (MVTR) of less than 6 g/m²/24 hr measured according to ASTM F1249 under the conditions of 38° C. and 90% Relative Humidity and/or an oxygen transmission rate of less than 28 cm³/m²/24 hr measured according to ASTM D3985 under the conditions of 23° C., 100% oxygen, and 100% Relative Humidity.

The terms “nonwoven fabric”, “nonwoven sheet”, “nonwoven layer”, and “nonwoven web” as used herein refer to a structure of individual fibers, filaments, or threads that are positioned in a random manner to form a planar material without an identifiable pattern, as opposed to a knitted or woven fabric. Examples of nonwoven fabrics include meltblown webs, spunbond webs, and composite sheets comprising more than one nonwoven web.

The term “machine direction” (MD) is used herein to refer to the direction in which a nonwoven web is produced (e.g. the direction of travel of the supporting surface upon which the fibers are laid down during formation of the nonwoven web). The term “cross direction” (XD) refers to the direction generally perpendicular to the machine direction in the plane of the web.

The term “spunbond fibers” as used herein means fibers that are melt-spun by extruding substantially continuous molten thermoplastic polymer material as fibers from a plurality of fine, usually circular, capillaries of a spinneret with the diameter of the extruded fibers then being rapidly reduced by drawing and then quenching the fibers.

The term “meltblown fibers” as used herein, means fibers that are melt-spun by meltblowing, which comprises extruding a melt-processable polymer through a plurality of capillaries as molten streams into a high velocity gas (e.g. air) stream.

The term “spunbond-meltblown-spunbond nonwoven fabric” (“SMS”) as used herein refers to a multi-layer composite sheet comprising a web of meltblown fibers sandwiched between and bonded to two spunbond layers. Additional spunbond and/or meltblown layers can be incorporated in the composite sheet, for example spunbond-meltblown-meltblown-spunbond webs (“SMMS”), etc.

The term “multiple component fiber” as used herein refers to a fiber that is composed of at least two distinct polymeric components that have been spun together to form a single fiber. The at least two polymeric components are arranged in distinct substantially constantly positioned zones across the cross-section of the multiple component fibers, the zones extending substantially continuously along the length of the fibers.

The term “bicomponent fiber” is used herein to refer to a multiple component fiber that is made from two distinct polymer components, such as sheath-core fibers that comprise a first polymeric component forming the sheath, and a second polymeric component forming the core; and side-by-side fibers, in which the first polymeric component forms at least one segment that is adjacent at least one segment formed of the second polymeric component, each segment being substantially continuous along the length of the fiber with both polymeric components being exposed on the fiber surface. Multiple component fibers are distinguished from fibers that are extruded from a single homogeneous or heterogeneous blend of polymeric materials. The term “multiple component nonwoven web” as used herein refers to a nonwoven web comprising multiple component fibers. A multiple component web can comprise single component and/or polymer blend fibers in addition to multiple component fibers.

As used herein, the term “film” includes sheet-like layers that are extruded directly onto one of the other layers in the lidding or blister components, as well as films that are formed in a separate film-forming step and then laminated to one or more other layers.

The calendered sheets of the present invention are prepared by smooth-calendering a multiple component nonwoven web. Suitable multiple component nonwoven webs include multiple component spunbond webs, spunbond-meltblown-spunbond (SMS) nonwoven webs, SMMS nonwoven webs, etc. wherein at least one of the spunbond layers comprises a multiple component spunbond web, which can be prepared using methods known in the art. Meltblown layers improve the basis weight uniformity of the fabric, resulting in improved visual uniformity. The multiple component nonwoven web preferably has a basis weight between about 1.0 and 3.5 oz/yd². The multiple component fibers forming the multiple component nonwoven web comprise a lower-melting component and a higher-melting component, wherein the lower-melting component has a melting point that is preferably at least about 90° C. below, preferably at least about 120° C. below the melting point of the higher-melting component. The difference in melting point permits calendering at temperatures sufficient to melt and cause significant flowing of the lower-melting component without melting or softening the higher-melting component, so that the fibrous character and strength of the higher-melting component are not significantly impacted. The multiple component fibers are selected such that the lower-melting component comprises at least a portion of the peripheral surface of the fibers. The multiple component fibers preferably have a sheath-core cross-section, but other cross-sections known in the art can also be used, such as side-by-side cross-sections. Sheath-core fibers may provide a more uniform distribution of the lower-melting component in the calendered sheet. Examples of suitable lower-melting/higher-melting polymer combinations include polyolefin/polyester and polyolefin/polyamide combinations. Suitable polyolefins include polypropylene and polyethylenes such as LLDPE, HDPE, low density polyethylene, very linear low density polyethylenes (VLLDPE) having a density from 0.915 to 0.900 g/ml, and combinations thereof. Suitable polyesters include poly(ethylene terephthalate), and poly(1,4-butylene terephthalate), and suitable polyamides include poly(hexamethylene adipamide) (nylon 6,6), polycaprolactam (nylon 6), and combinations thereof. Other suitable high melting polymers include polycarbonates, poly(ethylene naphthalate), liquid crystalline polymers such as those described in U.S. Pat. No. 5,525,700, which is hereby incorporated by reference, fluoropolymers, poly(vinyl chloride), and acrylic polymers. Other suitable low melting polymers include ionomeric polymers such as metal ion neutralized copolymers of ethylene with acrylic acid, methacrylic acid, or a combination thereof. In one embodiment, the nonwoven web is a spunbond web comprising bicomponent sheath-core spunbond fibers wherein the sheath is linear low density polyethylene and the core is poly(ethylene terephthalate). In another embodiment, the nonwoven web is a SMS, SMMS, etc. fabric wherein the spunbond layers comprise bicomponent sheath-core spunbond fibers wherein the sheath is linear low density polyethylene and the core is poly(ethylene terephthalate) and the meltblown layer(s) comprise sheath-core or side-by-side meltblown fibers comprising linear low density polyethylene and poly(ethylene terephthalate). The percentage of the lower-melting component can be between about 10 and 90 weight percent based on total polymer in the fiber, more preferably between about 20 and 80 weight percent. Using a higher percentage of the lower-melting component can in some cases result in sticking of the calendered sheet layer to the heat-sealing plate during fabrication of a blister package. When the lower melting component has a melting point of about 130° C. or less, such as LLDPE, the multiple component fibers preferably comprise less than 50 weight percent of the lower-melting component to avoid sticking during heat-sealing. The percentage of the lower-melting polymeric component is selected to provide the desired strength, permeability, etc. of the calendered sheet.

The multiple component nonwoven web is thermally bonded by passing it through a calender nip, such as a nip formed by pressing two smooth-surfaced rolls against each other. One of the rolls is generally a heated metal roll and the second (back-up) roll generally has a surface made of a softer material, such as a rubber-coated roll. The second roll is generally unheated and preferably has a Shore D hardness between about 70 and 100. The hardness of the back-up roll combined with the calender nip pressure determines the size of the nip footprint, with softer rolls having the potential for significant deflection that will create a large contact footprint between the rolls. The larger the footprint, the more time the nonwoven web is subjected to the temperature and pressure in the nip and the larger the degree of thermal bonding of the web. The calendering process conditions (temperature, pressure, and residence time) used to form the calendered multiple component sheets of the present invention are selected to cause the lower-melting polymeric component of the multiple component fibers in the web to flow into and at least partially fill the interstitial spaces between the fibers. The lower-melting component may substantially completely lose its fibrous characteristics to form a continuous or semi-continuous film-like structure in the calendered sheet. Smooth-calendered sheets that have been calendered under conditions that cause significant flow of the lower-melting polymeric component into the interstitial spaces between the fibers are referred to herein as heavily calendered sheets. Heavily calendered sheets are distinguished from smooth-calendered sheets that have been calendered under conditions that result primarily in inter-fiber bonding at fiber cross-over points by melting/softening of the lower melting polymeric component without significant flowing of the lower-melting component. Multiple component sheets that are smooth-calendered under conditions that result in a lesser degree of flowing of the lower-melting polymer component do not have the combination of properties of the more heavily calendered sheets of the present invention.

In order to achieve the desired degree of polymer flow during calendering, it is necessary to transfer heat to the center of the fibrous nonwoven web while not causing the outside of the web to melt and stick to the calendering rolls. The heated roll temperatures are kept close to the melting point of the lower-melting polymeric component and the residence time in the nip is adjusted by the line speed and nip pressure until the desired amount of polymer flow is obtained. The difference between the temperature of the roll heating medium (e.g. oil, electric, etc.) and the surface temperature of the calender roll is a strong function of the calendering equipment used and care is required to ensure that the rolls are not over- or under-heated. The fabric can be pre-heated prior to passing through the calender nip(s), such as wrapping on a pre-heating roll or other methods known in the art such as passing a heated gas through the fabric.

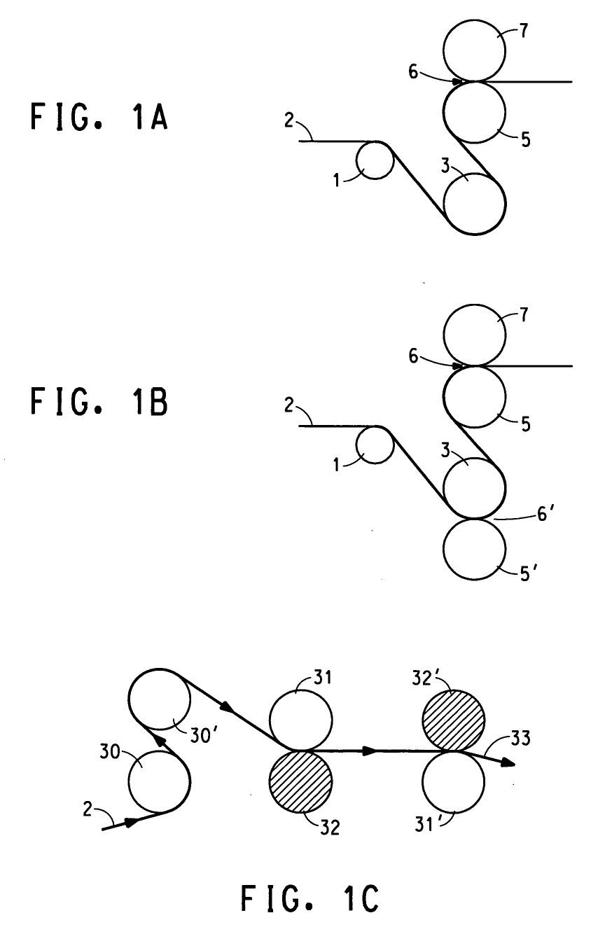

The heavily calendered sheets of the present invention can be prepared using a variety of calender roll configurations known in the art. FIG. 1A is a schematic diagram of a calendering process suitable for calendering both sides of a sheet in two passes. Multiple component nonwoven web 2 is passed over a change-of-direction roll 1 and around stainless steel pre-heating roll 3 to pre-heat the first side of the web prior to passing the nonwoven web through a nip 6 formed by calender rolls 5 and 7. Calender roll 5 is a heated smooth stainless steel roll. Calender roll 7 is a smooth, unheated back-up roll. The second side of the fabric is bonded by making a second pass through the calendering process with the fabric inverted such that the second side contacts the pre-heating roll. Alternately, a second set of heated calender/back-up rolls (not shown) can be added downstream of calender rolls 5 and 7 to bond both sides of the fabric in a single pass. The fabric can be passed over an optional second pre-heating roll before entering the second calender nip.

FIG. 1B is a schematic diagram of an alternate calendering process suitable for calendering both sides of a sheet in a single pass. Roll 5′ is a back-up roll and rolls 3,5, and 7 are as described above for FIG. 1A. The first side of sheet 2 is calendered in nip 6′ and the second side of the sheet is calendered in nip 6. Using the roll configuration of FIG. 1B, there is not a separate pre-heat roll upstream of the calender nip, but rather pre-heating is provided by a partial wrap on the heated metal roll immediately prior to entering the calender nip.

FIG. 1C is a schematic diagram of another calendering process suitable for use in preparing the smooth-calendered sheets of the present invention in a single pass. Multiple component nonwoven web 2 is passed in an S-wrap around first and second pre-heat rolls 30, 30′ to pre-heat both sides of the web. The pre-heated nonwoven web is then passed through a first calender nip formed by smooth heated metal roll 31 and smooth unheated back-up roll 32 to smooth-calender the first side of the fabric, followed by passing the web through a second calender nip formed by smooth heated metal roll 31′ and smooth, unheated back-up roll 32′ to provide heavily calendered sheet 33.

The calendering process can be performed in-line immediately after formation of the nonwoven web. Alternately, a pre-formed nonwoven web can be calendered in a separate process. The pre-formed nonwoven web can be pre-bonded, such as by thermal point bonding prior to being rolled up for calendering in a separate step.

When the multiple component nonwoven web comprises one or more meltblown layers, calendering conditions are selected as described above, such that the lower melting component of the spunbond layers melts and flows into the interstitial spaces between the spunbond fibers. The meltblown layer(s) can be a single component meltblown layer or a multiple component meltblown layer. When the meltblown layer is a multiple component layer of meltblown fibers comprising a lower melting component and a higher melting component, the calendering conditions can be selected such that the lower melting meltblown component melts and flows into the interstitial spaces between the meltblown fibers. Alternately, the calendering conditions can be selected such that there is no significant flowing of the lower melting meltblown component.

Heavily calendered sheets of the present invention formed from multiple component spunbond, SMS, or SMMS, etc. fabrics are especially suitable for use as a component in a multi-layer laminate as lidding for child-resistant packaging, such as child-resistant blister packages. In this end use, the multi-layer lidding component includes at least one barrier layer and at least one calendered multiple component sheet of the present invention. The blister packages of the present invention include peel-open, tear-open, and peel off-push through packages. When used in a multi-layer laminate as lidding for child-resistant packaging, the calendered multiple component sheet preferably has an Elmendorf tear measured in both the MD and XD directions of between about 0.5 lb and 6.0 lb, a Graves tear measured both the MD and XD directions of at least about 4.0 lb, and a Spencer Puncture of at least about 0.70 J.

FIG. 2 illustrates a schematic elevation view of a blister package according to the present invention. The blister package comprises two layers of material, a blister component and a lidding component. Lidding component 4, which comprises a multi-layer laminate comprising at least one heavily calendered sheet of the present invention, is heat-sealed to a blister component comprising a plurality of cavities or blister units 8. The lidding and blister components are heat-sealed in the shoulder areas 10 that separate the individual cavities. The shoulder areas of the package generally include an intersecting grid of perforated lines 12 between the individual blisters or groups of individual blisters. The perforations extend through the thickness of each layer, with the perforated lines of the blister and lidding components being coincident with each other. Each blister unit is releasably secured to adjacent blister units by the perforated lines. In order to gain access to a blister unit, the perforated lines defining the boundaries of that unit with other blister units are torn. This can be accomplished by tearing at least two intersecting perforated lines to separate the desired blister unit from the remainder of the package, or by tearing along only one perforated line to provide access to the blister unit, while leaving it secured to one or more of the other blister units of the package. Generally a corner of the lidding on each blister unit is not fully adhered to the blister component so that pulling of the non-adhered corner of the lidding from the blister component results in peeling of the seal therebetween, providing access to the packaged item (e.g. pill, capsule, etc.) in the blister unit (peel open package). Using a suitable multi-layer laminate as the lidding component, a peel off-push through package can be formed, as described in more detail below. Alternately, individual blister units can be provided with a pre-formed notch on one of the edges thereof, allowing the package to be opened by tearing at the pre-formed notch (tear open package).

Blister component 8 is formed from a forming web that comprises at least one barrier layer, for example a polymeric film, coated polymeric film, metal foil, or film-foil laminate. Forming webs suitable for forming the blister component are known in the art. For example, the blister component can be prepared by thermoforming cavities into a barrier film. Alternately, the blister component can be formed from a soft-tempered or a hard-tempered foil such as an aluminum foil layer. Films and foils suitable for forming the blister component generally have a thickness between about 5.0 mils (0.125 mm) and 15 mils (0.38 mm) for child-resistant packaging. For example, a typical film thickness is about 10 mils (0.25 mm). The blister component can be formed from a multi-layer sheet structure, for example a multi-layer film or a film-foil laminate.

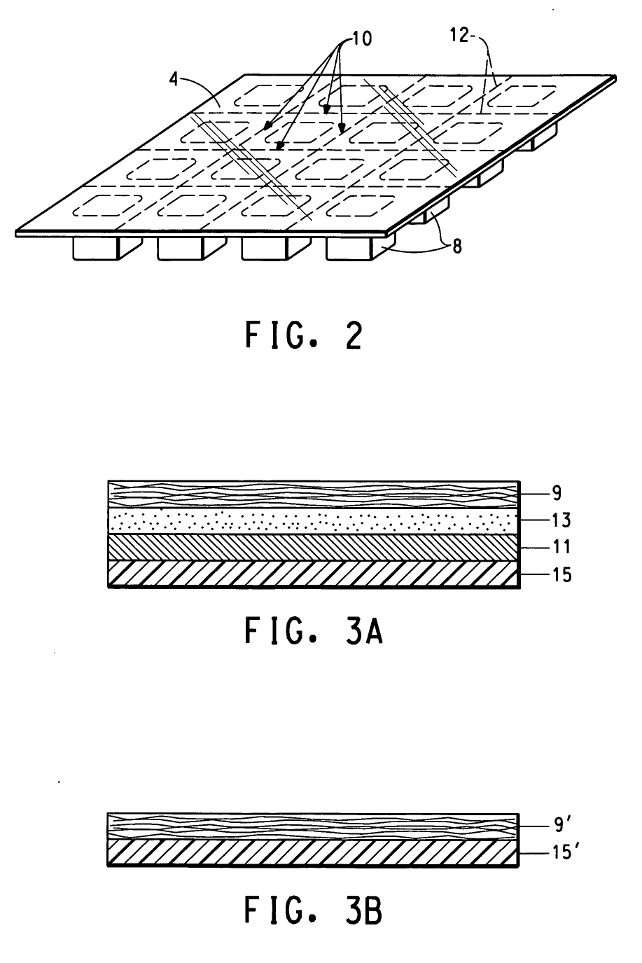

FIG. 3A is a cross-sectional view of a multi-layer laminate comprising a heavily calendered multiple component sheet layer of the present invention suitable for use as the lidding component in peel-open, tear-open, and peel off-push through blister packages of the present invention. Heavily calendered multiple component sheet layer 9 is bonded to barrier layer 11 by intervening adhesive tie layer 13. Heat-seal layer 15 is adhered to the barrier layer on the side of the barrier layer opposite the tie layer. A blister package is formed by heat-sealing the lidding component to the blister component with heat-seal layer 15 facing the blister component such that calendered multiple component sheet layer 9 forms one of the outer surfaces of the blister package.

Tie layer 13 can form a peelable seal (e.g. in a peel off-push through package) or a non-peelable seal (e.g. in a peel-open or tear-open package) between the calendered sheet layer and the barrier layer, depending on the desired method for opening the blister package. A seal or bond is considered non-peelable if the layers bonded by the non-peelable seal are not readily opened by an adult by hand-peeling. Generally a seal having a peel strength between about 3 to 4 lb/in is preferred for a peelable seal. Peel strengths less than about 3 lb/in are generally peeled too easily to be useful in child-resistant packages. Seals having a peel strength greater than about 4 lb/inch are generally considered to be non-peelable or permanent seals. Peel strength can be measured according to ASTM F 88-0, which is hereby incorporated by reference, using the unsupported method of clamping the sample described therein. Alternately, heat-seal layer 15 can form a peelable seal (e.g. in a peel-open package) or a non-peelable seal (e.g. in a peel off-push through or tear-open package) between the barrier layer and the blister component.

Materials suitable for use as barrier layer 11 in FIG. 3A include foil sheets such as aluminum foil and laminated structures comprising a foil layer such as film-foil laminates, as well as mono-layer, multi-layer, and coated polymeric films, and metalized polymeric films. Examples of materials useful as either the barrier layer in the multi-layer lidding component or as the blister component include poly(vinyl chloride) (PVC) used as a mono-layer film, PVC film coated with poly(vinylidene chloride) (PVdC), PVC film laminated with poly(chlorotrifluoroethylene) (PCTFE) film such as Aclar® PCTFE film available from Honeywell, Inc. (Morris Township, N.J.), cyclo-olefin-copolymer (COC) used as part of a laminated or co-extruded structure, cold-formable foil such as PVC/aluminum/nylon laminated structures, mono-layer aluminum foil, polypropylene (PP) used as a mono-layer film, poly(ethylene terephthalate) (PET) used as a mono-layer film, and poly(ethylene terephthalate) copolymers that have been modified with 1,4-cyclohexanedimethanol, available from Eastman Chemicals (Kingsport, Tenn.) as PETG copolymers, used as a mono-layer film.

In one embodiment the barrier layer 11 comprises a polymeric film comprising a polymeric coating. For example, the barrier layer can comprise a PVdC-coated polyester film such as PVdC-coated Mylar® polyester films (e.g. M30 and M34 films, available from DuPont Teijin Films). In another embodiment, the barrier layer comprises a polymeric film that has been coated with a ceramic material. Ceramic materials suitable for coating polymeric films include oxides, nitrides, or carbides of silicon, aluminum, magnesium, chromium, lanthanum, titanium, boron, zirconium, or mixtures thereof. Methods for depositing ceramic coatings onto a substrate are known in the art, such as by deposition from the vapor or gaseous phase under vacuum onto a film layer in thicknesses of between about 5 to 500 nm. Suitable ceramic-coated films include films made of a thermoplastic material, such as polyolefin films having a thickness of 23 to 100 μm or polyester films having a thickness of 12 to 80 μm, that have been coated with at least one 5 to 500 nm thick layer of SiOₓ, where x is a number ranging from 1.1 to 2, or with Al_{y}O_{z}, where the ratio y/z is a number ranging from 0.2 to 1.5. Alternately, the barrier layer can comprise a metalized film prepared using processes known in the art such as vacuum deposition or sputter coating. In one embodiment, the barrier layer is a metalized polyester film, for example a poly(ethylene terephthalate) film, that has a layer of aluminum metal coated thereon; preferably the metal layer is between about 10 Angstroms to 1000 Angstroms thick and the film is preferably at least 12 microns thick. Metalized polyester films are known in the art and include aluminum-coated polyester films such as Mylar® MC2 aluminum-coated polyester film (available from DuPont Teijin Films). When the barrier layer of the lidding component comprises a ceramic-coated or a metalized polymeric film, the film can be ceramic-coated or metalized on one or both sides. The polymeric film is preferably ceramic-coated or metalized on one side thereof and the lidding is preferably constructed such that the metalized or ceramic-coated side of the film contacts adhesive tie layer 13 to avoid flaking off of the metalized or ceramic layer onto the packaged material when the package is opened. Metalized and ceramic-coated films generally have better barrier properties than unmetalized and uncoated films and therefore are preferred when higher barrier is required than can be achieved with an un-metalized or uncoated film.

FIG. 3B is a cross-sectional view of a second embodiment of a multi-layer laminate suitable for use as the lidding component in peel-open and tear-open blister packages of the present invention. The lidding component includes heavily calendered bicomponent sheet layer 9′ and heat-seal layer 15′. In this embodiment, the heat-seal layer is selected such that it is a barrier layer as well as being heat-sealable, thus eliminating the need for separate barrier and heat-seal layers. When the heat-sealable barrier layer is applied as a coating on the calendered sheet layer, it completely coats the calendered layer to provide the desired barrier properties in the blister package. For example, PVdC at a basis weight ranging from 5 g/m² to 120 g/m² coated on a calendered sheet layer provides sufficient barrier properties as well as functioning as a heat-seal layer. Depending on the selection of the heat-sealable barrier layer and the blister component, the heat seal can be peelable or non-peelable. When it is desired to form a peel-open package, the heat-sealable barrier layer and the blister component are selected such that the heat seal is peelable. When it is desired to form a tear-open package, the heat seal is preferably non-peelable. In one embodiment of the present invention according to FIG. 3B, a tear-open package is formed using a PVdC blister component and a PVdC heat sealable barrier layer (heat seal is non-peelable). In another embodiment of the present invention according to FIG. 3B, a peel-open package is formed using a PVC blister component and a PVdC heat-sealable barrier layer, where the PVdC formulation is selected to form a peelable seal with the PVC blister. The lidding shown in FIG. 3B optionally includes a non-peelable tie layer (not shown) between the heavily calendered sheet layer and heat-seal/barrier layer. For example the tie layer can be a polyester-based polyurethane composition such as Adcote® polyurethane adhesives available from Rohm & Haas (Philadelphia, Pa.).

In one embodiment of the present invention the heat-seal layer comprises a peelable sealant, thus providing a peel-open blister package. Whether or not a particular heat-seal layer forms a peelable seal may depend on the nature of the layers to which it is sealed (e.g. the blister component and barrier layer for the embodiment shown in FIG. 3A or the blister component and the heavily calendered composite sheet layer for embodiments shown in FIG. 3B). In a peel-open configuration, the package is opened by peeling the multi-layer lidding component away from the blister component, with the peeling occurring between the heat-seal layer 15 or 15′ and the blister component (not shown). Peelable sealants suitable for use in the heat-seal layer of the packages of the present invention include poly(vinylidene chloride), or solvent-based sealants such as modified vinyl/acrylic sealants available from Watson Rhenania (Pittsburgh, Pa.) such as JVHS-157-LT1 sealant, as well as extrudable sealants, for example blends of polyolefin resins comprising primarily ethylene vinyl acetate or ethylene methyl acrylate copolymers, such as Appeel® resins, available from E. I. du Pont de Nemours and Company (Wilmington, Del.). The heat-seal layer can be applied to the barrier layer of the lidding component using methods known in the art including but not limited to roll coating, gravure coating, spray coating, and extrusion coating. In a peel-open package, a non-peelable adhesive tie layer is preferably used to join the calendered sheet layer to the barrier layer so that the calendered sheet and barrier layers are strongly bonded together, allowing the multi-layer lidding to be cleanly pulled away from the blister component without delamination occurring between the calendered sheet and barrier layers. Non-peelable adhesive tie layers suitable for use in lidding used in a peel-open package of the present invention include solvent-based two-component dry-bond adhesive compositions such as polyester-based polyurethane adhesives, for example Adcote® polyurethane-based adhesives available from Rohm & Haas (Philadelphia, Pa.). In a dry-bond adhesive process, the adhesive is applied to either the barrier layer or the nonwoven layer or both, and the two layers are bonded together while the adhesive is “dry” or substantially free of solvent. If the starting adhesive composition comprises a solvent, it is dried prior to laminating the nonwoven layer to the barrier layer. Other adhesive compositions which provide a non-peelable tie layer include extrudable resins such as modified ethylene vinyl acetate, ethylene vinyl acetate, and ethylene methyl acrylate based resins, for example Bynel® and Nucrel® modified ethylene vinyl acetate and modified ethylene methyl acrylate resins, available from E. I. du Pont de Nemours and Company (Wilmington, Del.).

In another embodiment of a blister package of the present invention, the blister package is a peel off-push through package wherein the lidding component comprises a multi-layer laminate such as that shown in FIG. 3A. The outer heavily calendered sheet layer 9 is adhered to a frangible barrier layer 11 by a peelable tie layer 13, and is peeled from the package to reveal the frangible barrier layer through which the packaged material is pushed. A layer is considered to be frangible if a packaged material can be removed by rupturing the layer by applying pressure to the exterior of the blister cavity. Peeling may occur between the heavily calendered sheet layer 9 and the adhesive tie layer 13 or between the adhesive tie layer 13 and the barrier layer 11. The adhesive tie layer is preferably selected such that it remains adhered to the heavily calendered sheet layer and peels cleanly away from the barrier layer when the package is opened without tearing or otherwise rupturing the barrier layer. That is, the adhesive tie layer preferably has a high adherence to the calendered sheet layer and a relatively lower adherence to the frangible barrier layer. If peeling occurs between the nonwoven layer and the adhesive tie layer, the adhesive tie layer should also be a frangible layer. For example, in a peel off-push through package comprising a lidding component according to FIG. 3A, the adhesive tie layer 13 is a peelable layer such that the nonwoven layer 9 can be peeled away from the barrier layer 11 of the lidding component, and wherein the combined barrier layer/heat-seal layer 11/15 (for peeling between the adhesive tie layer and the barrier layer) or combined adhesive tie layer/barrier layer/heat-seal layer 13/11/15 (for peeling between the calendered sheet layer and tie layer) is frangible. Examples of frangible barrier layers include metal foils (e.g. aluminum foil), frangible polymeric films (e.g. biaxially-oriented poly(chlorotrifluoroethylene) films), frangible metalized polymeric films, and frangible ceramic-coated polymeric films. The frangible layer(s) are selected such that once the calendered sheet layer (or combined calendered sheet/adhesive tie layer) is peeled away from the package, the pharmaceutical or other packaged material can be pushed through the frangible layer(s). The adhesive tie layer can be extruded or coated onto one or both of the calendered sheet layer or frangible barrier layer and the calendered sheet layer and barrier layer bonded together by the intermediate tie layer. Examples of suitable peelable tie layers include modified vinyl/acrylic compositions, such as JVHS-157-LT1 modified vinyl/acrylic adhesive available from Watson Rhenania (Pittsburgh, Pa.), or blends of polyolefin resins comprising primarily ethylene vinyl acetate or ethylene methyl acrylate copolymers, such as Appeel® polyolefin resins, available from E. I. du Pont de Nemours and Company (Wilmington, Del.), and solvent-based modified acrylic pressure sensitive adhesive, such as Adcote L74X105 from Rohm & Haas (Philadelphia, Pa.). The heat-seal layer in a peel off-push through package is selected such that it forms a non-peelable seal between the blister component and the barrier layer in the lidding. Examples of suitable permanent (non-peelable) sealants include modified vinyl/acrylic compositions such as JVHS-157-2, or a modified polyester sealant such as GNS01-014, both available from Watson Rhenania (Pittsburgh, Pa.).

When a tear-open package is desired, the adhesive tie layer and heat-seal layer of FIGS. 3A and 3B are selected such that non-peelable bonds/seals are formed between the barrier layer and the blister component and between the nonwoven layer and the barrier layer. This allows the package to be torn cleanly at a pre-formed notch in the package without peeling occurring between the various layers in the multi-layer lidding component.

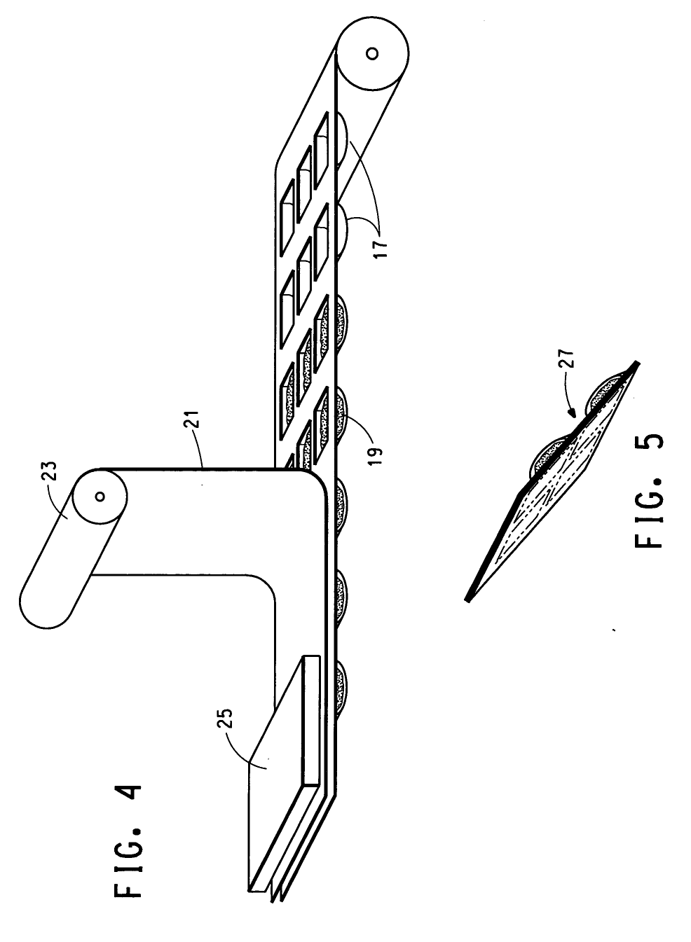

The blister package of the present invention can be manufactured using methods known in the art. FIG. 4 illustrates a process that is suitable for forming a blister package of the present invention. The blister cavities or units 17 are generally thermoformed into a forming web in-line just prior to filling the cavities with the material 19 to be packaged. The lidding component 21 is unwound from roll 23 and brought into contact with the formed and filled blister component such that the heat-seal layer of the lidding component contacts the blister component. The lidding and blister components are heat sealed, typically using a heated platen 25 with or without a pattern. Generally, some areas are not sealed to provide a starting point for peeling off the lidding or selected layers of the lidding prior to removing the product. If the lidding component is not pre-printed, printing is generally done just before heat sealing (not shown). After heat-sealing, the individual blisters are generally perforated using methods known in the art (not shown) so that they can be removed at point of use. If the blister package is a tear-open package, notches are formed in the individual blisters during the perforation step. The notches are preferably contained internal to the package such that they are not exposed until the individual blister unit is removed at point of use. The notch can also be formed on one of the external edges of the blister package however forming the notches internal to the package decreases the likelihood that a child will be able to tear open the package. Individual blister packages 27, which can comprise multiple blisters (as shown in FIG. 5) or a single blister, are then cut from the continuous sheet of sealed blisters.

It is important that calendered sheets used in multi-layer laminates for lidding in a child-resistant package have high Graves tear to prevent unintended tearing of the package by a child. The Elmendorf tear properties of the calendered sheet are important to the opening of each blister unit as well as in the separation of each blister unit from a package comprising multiple blisters. It is important that the Elmendorf tear be high enough that the lidding component does not tear as it is being peeled away from the blister component. However, the Elmendorf tear should be low enough that individual blister units can be separated by tearing the lines of perforation separating individual blisters. The lidding should also have high puncture resistance so that a child cannot bite through the lidding. The calendered sheets of the present invention have a combination of Graves tear, Elmendorf tear, and Spencer puncture that is superior to conventional paper-film-foil laminates.

### TEST METHODS

In the description above and the examples that follow, the following test methods are employed to determine various reported characteristics and properties. ASTM refers to the American Society for Testing and Materials. TAPPI refers to Technical Association of Pulp and Paper Industry.

Basis Weight is a measure of the mass per unit area of a fabric or sheet and is determined by ASTM D-3776, which is hereby incorporated by reference, and is reported in g/m².

The Melting Point of a polymer as reported herein is measured by differential scanning calorimetry (DSC) according to ASTM D3418-99, which is hereby incorporated by reference, and is reported as the peak on the DSC curve in degrees Centigrade. The melting point was measured using polymer pellets and a heating rate of 10° C. per minute.

Shore D Hardness is a measure of rubber hardness and is measured according to ASTM D2240, which is hereby incorporated by reference.

Thickness of the nonwoven materials is measured by TAPPI-T411 om-97, which is hereby incorporated by reference.

Elmendorf Tear is a measure of the force required to propagate an initiated tear from a cut or a nick. Elmendorf Tear is measured according to ASTM D1424, which is hereby incorporated by reference, in both the MD and the XD and is reported in units of lb or N.

Graves Tear is a measure of the force required to initiate a tear and is measured according to ASTM D1004, which is hereby incorporated by reference, in both the MD and the XD and is reported in units of lb or N.

Spencer Puncture is a measure of the ability of a substrate to resist puncture by impact. Spencer puncture is measured for nonwoven fabrics and nonwoven/foil laminates using a bullet-shaped probe and is determined by ASTM D3420 (modified for 9/16 inch diameter probe) with a pendulum capacity of 5.4 Joules, which is hereby incorporated by reference. It is reported in Joules.

Strip Tensile Strength is a measure of the breaking strength of a sheet and was measured according to ASTM D5035, which is hereby incorporated by reference, and is reported in units of lb or N. Five measurements were made and averaged in both the machine direction and the cross-direction.

### EXAMPLES

### Example 1

This Example demonstrates the preparation of a smooth-calendered LLDPE/PET sheet by calendering a sheath/core spunbond nonwoven fabric under conditions that result in significant flowing of the sheath component into the interstitial spaces between the fibers, and fabrication of a foil laminate and child-resistant blister packages therefrom.

The sheath/core spunbond fabric was prepared in a bicomponent spunbond process using linear low density polyethylene with a melting point of about 126° C. as the sheath, and poly(ethylene terephthalate) polyester with a melting point of about 260° C. as the core. The polyester resin was crystallized and dried before use.

The polyester and the polyethylene were heated in separate extruders and were extruded, filtered and metered to a bicomponent spin block designed to provide a sheath-core filament cross section. The polymers were metered to provide fibers that were 30% polyethylene (sheath) and 70% polyester (core), based on fiber weight. The filaments were cooled in a quenching zone with quenching air provided from two opposing quench boxes. The filaments then passed into a pneumatic draw jet where the filaments were drawn and then deposited onto a laydown belt with vacuum suction. The resulting spunbond web had a basis weight of about 2 oz/yd² (67.8 g/m²) and was lightly point bonded for transport prior to winding on a roll.

The spunbond fabric was heavily-calendered at a line speed of 45 ft/min (13.7 m/min) in a calender having the roll configuration shown in FIG. 1B, with two sequential calender nips formed by two sequential pairs of rolls, each calender nip comprising a smooth chrome-coated metal roll and a smooth rubber-covered back-up roll having a Shore D hardness of approximately 90. The metal roll forming the first nip was heated to a temperature of 245° F. (118° C.) and the metal roll forming the second nip was heated to a temperature of 250° F. (121° C.). The rubber-covered back-up rolls were unheated. A nip pressure of 400 lb/linear inch was used for each nip. The properties of the heavily calendered sheet are reported below in Table I.

The heavily calendered bicomponent sheet was laminated to a 0.93 mil (0.024 mm) thick soft-tempered aluminum foil obtained from Alcoa (Pittsburgh, Pa.) using Adcote 812/811B solvent-based poly(ethylene terephthalate)-based polyurethane permanent adhesive tie layer obtained from Rohm & Haas (Philadelphia, Pa.). An Egan dry-bond coater/laminator was used to perform the lamination. The Adcote 812/811B was mixed at a ratio of 68.3 percent by weight, 6.2 percent by weight 811BF, and 25.5 percent by weight ethyl acetate and the adhesive was applied using a reverse gravure coating process. The aluminum foil web was unwound from a primary unwind and the adhesive was applied to the aluminum foil web using a reverse rotating gravure roll. The gravure roll was engraved with a 70 line per inch (27.5 line per cm) quadrangular pattern. The machine speed was 150 ft/min (45.7 m/min). The adhesive was applied at a dry coating weight of about 3.33 lb/ream (5.33 g/m²). A hot air impingement dryer using air heated to 180° F. (82.2° C.) was used to dry the coated aluminum foil web to remove the solvent present in the tie layer adhesive.

After drying, the adhesive-coated aluminum foil web layer was laminated to the heavily calendered bicomponent sheet, which was unwound from a roll and contacted with the adhesive-coated side of the aluminum foil web in a nip formed by two cylindrical calender rolls. One of the rolls was a rubber-covered roll and the second roll was a steel roll heated to 180° F. (82.2° C.) by internal water heating. The aluminum foil web contacted the heated steel roll in the nip and the calendered bicomponent sheet contacted the rubber-surfaced roll. The laminated substrate was then rewound on the rewinder.

A solvent-based peelable heat seal layer was then applied to the aluminum foil side of the above-described spunbond nonwoven/aluminum foil laminate using the reverse gravure coating process described above. The peelable heat seal composition used was a vinyl/acrylic solvent-based sealant (Adcote 90X13, supplied by Rohm&Haas, Philadelphia, Pa.). The heat-seal coating was applied at 3.63 lb/ream (5.8 g/m²) to the nonwoven/foil laminate. After applying the sealant, the coated material was dried using the same hot air impingement dryer described above and an air temperature of 200° F. (93.3° C.) to remove the ethyl acetate solvent. After drying the laminate was rewound on the rewinder. Properties of the foil laminate of Example 1 are compared to a conventional paper-film-foil laminate that is used in the art as lidding in blister packages (CR-417, available from Hueck Foils (Wall, N.J.)) in Table I below. The results demonstrate the significant improvement in Spencer Puncture and Elmendorf Tear of the lidding of the present invention compared to the prior art lidding material. The puncture resistance of the foil laminate prepared in Example 1 was more than six times greater than the conventional lidding material.

### Comparative Example A

This Example demonstrates the preparation of a smooth-calendered LLDPE/PET sheet from a sheath/core spunbond nonwoven fabric by calendering under conditions that do not result in significant flowing of the sheath component into the interstitial spaces between the fibers, and fabrication of a child-resistant blister package therefrom.

A lightly bonded sheath/core spunbond nonwoven fabric prepared using a calender roll configuration shown in FIG. 1A in two passes. The size and composition of the metal rolls and back-up rolls were identical to those described above in Example 1, although the roll configuration was different. The spunbond fabric was smooth-calendered under the following conditions: line speed=50 ft/min, nip pressure in both nips=500 lb/linear inch, and surface temperature of metal rolls=105° C., to provide a calendered spunbond sheet having a lower level of bonding than the calendered spunbond sheet of Example 1.

An aluminum foil laminate was prepared using the procedure described above for Example 1. Properties of the foil laminate are reported above in Table I. The foil laminate of Example 1 had higher Graves Tear, lower Elmendorf Tear, and higher puncture resistance than the aluminum foil laminate of Comparative Example A. It was observed that the calendered spunbond sheets of Example 1 tore very cleanly without leaving a significant number of loose fibers exposed along the edge of the sheet, as opposed to the calendered spunbond sheet of Comparative Example A, which had a fuzzy edge when torn, with fibers in the center of the sheet separating from the sheet at the tear.

TABLE I

| | | | Comp | CR-417 |
|---|---|---|---|---|
| | Example 1 | Example 1 | Ex A | Paper- |
| | Calendered | Al Foil | Al Foil | Al Foil |
| | Spunbond | Laminate | Laminate | Laminate |
| MD Elmendorf Tear | 2.0 | 1.45 | 8.61 | 0.25 |
| (lb) | | | | |
| XD Elmendorf Tear | 2.9 | 3.0 | 7.65 | 0.20 |
| (lb) | | | | |
| MD Graves Tear (lb) | 5.9 | 5.9 | 4.24 | 5.36 |
| XD Graves Tear (lb) | 6.8 | 6.9 | 4.36 | 6.28 |
| MD Strip Tensile | 27.4 | 27.7 | 13.22 | 42.07 |
| (lb/in) | | | | |
| XD Strip Tensile | 16.9 | 18.05 | 11.09 | 31.70 |
| (lb/in) | | | | |
| Spencer Puncture | 2.88 | 2.52 | 1.03 | 0.40 |
| (J) | | | | |
| Thickness (mils) | 3.4 | 4.65 | 4.17 | 3.66 |

Blister packages were prepared using the foil laminate of Example 1 as the lidding component on a Klockner Medipak CP-2 form-fill-seal blister packaging machine. The forming web used to form the blister component was 10 mil (0.254 mm) Pentapharm M570/01 poly(vinyl chloride) film supplied by Klockner Pentaplast of America (Gordonsville, Va.). The platen used to heat seal the lidding to the blister component was heated to a temperature of 180° C. to obtain peel-open packages. There was no sticking or tearing of the calendered spunbond layer to the heat sealing die or any tearing of the sheet during the perforating/die cutting process. The foil laminate die cut and perforated equivalent to products currently used in this end use such as paper-film-foil laminates. Print quality on the calendered sheet of Example 1 was acceptable when printed with flexographic, thermal transfer, and inkjet methods.

Numerous blister packages of the present invention were peeled open and each sample peeled cleanly, which represents a significant improvement compared to blister packages known in the art that utilize a paper/film/foil laminate as the lidding, which are prone to tearing during peeling. Individual blisters were readily separated from a multi-blister package by tearing at the perforations while at the same time being sufficiently tear resistant to be suitable for use in a child resistant package. In addition to the improved tear properties, blister packages prepared according to the present invention are expected to be much more difficult for a child to chew through than conventional blister packages due to the high puncture resistance. It is believed that the combination of relatively high Graves Tear, intermediate Elmendorf Tear, and high Spencer Puncture resistance provided by the highly calendered spunbond nonwoven sheet provides the desired combination of clean peel, puncture resistance, and ease of tearing at perforations or other pre-formed notches, etc. that is desirable for child resistant packaging.

Blister packages were prepared as described above for Example 1, except that the foil laminate of Comparative Example A was used as the lidding. During the heat-sealing step, the spunbond layer stuck to the heat sealing die resulting in tearing of the lidding. The lidding also tore during the perforating/die cutting steps. It was also found that it was difficult to separate individual blisters from a multi-blister package due to difficulty tearing at the perforations. This is believed to be due primarily to the high Elmendorf tear properties of the calendered bicomponent sheet-foil laminate of Comparative Example A. In addition, the quality of printing on the calendered spunbond sheet of Comparative Example A was poor when printed with flexographic, thermal transfer, and inkjet methods.

### Examples 2a and 2b

These Examples demonstrate preparation of heavily calendered sheets of the present invention suitable for use in blister packaging.

Sheath-core spunbond webs were prepared as described above for Example 1. The spunbond webs were heavily-calendered using the roll configuration shown in FIG. 1C. The calendering pressure was 400 pli in each calender nip. The spunbond web used in Example 2a had a basis weight of about 2 oz/yd² and the spunbond web used in Example 2b had a basis weight of about 2.5 oz/yd². Calendering process conditions and calendered sheet properties are given below in Table II.

### Comparative Examples B and C

These Examples demonstrate the preparation of a smooth-calendered sheets from LLDPE/PET sheath/core spunbond nonwoven fabrics by calendering under conditions that do not result in significant flowing of the sheath component into the interstitial spaces between the fibers.

The starting spunbond fabrics used in Examples 2a and 2b were used to prepare the calendered sheets of Comparative Examples B and C, respectively. Calendering process conditions and calendered sheet properties are given below in Table II.

TABLE II

| | Ex 2a | Comp. Ex. B | Ex 2b | Comp Ex. C |
|---|---|---|---|---|
| Basis Wt | 2.0 | 2.0 | 2.5 | 2.5 |
| (oz/yd²) | | | | |
| Line Speed (ft/min) | 200 | 300 | 150 | 300 |
| Pre-heat Roll 1 (° F.) | 260 | 270 | 270 | 270 |
| Nip 1 Temp (° F.) | 269 | 270 | 269 | 265 |
| Pre-heat Roll 2 (° F.) | 250 | 265 | 255 | 265 |
| Nip 2 Temp (° F.) | 269 | 275 | 269 | 270 |
| MD Elmendorf Tear(lb) | 2.7 | 3.5 | 3.6 | 4.0 |
| XD Elmendorf Tear (lb) | 3.4 | 6.6 | 5.8 | 8.1 |
| MD Graves Tear (lb) | 5.3 | 5.3 | 7.3 | 5.0 |
| XD Graves Tear (lb) | 7.0 | 6.1 | 8.8 | 6.8 |
| MD Strip Tensile (lb/in) | 24.8 | 22.5 | 34.0 | 28.0 |
| XD Strip Tensile (lb/in) | 12.8 | 10.3 | 18.7 | 13.4 |
| Spencer Puncture (J) | 0.79 | 1.07 | 1.02 | 0.79 |

The calendered sheets of Comparative Examples B and C have Elmendorf Tear values measured in the cross direction of 6.6 lb and 8.1 lb respectively, which is too high to provide acceptable performance in blister packaging due to the difficulty in tearing at the perforations.

What is claimed is:

1. A heavily calendered multiple component spunbond sheet comprising continuous multiple component spunbond filaments, the multiple component filaments comprising between about 10 and 90 weight percent of a first lower-melting polymeric component and between about 90 and 10 weight percent of a second higher-melting polymeric component, the first polymeric component comprising at least a portion of the peripheral surface of the filaments, wherein interstitial spaces between the filaments are at least partially filled by the lower-melting component and are substantially free of separately added resin binder, said sheet having an Elmendorf tear measured in both the machine direction and the cross direction of between 0.5 lb and 6.0 lb, a Graves tear measured in both the machine direction and the cross direction of at least 4.0 lb, and a Spencer Puncture of at least 0.70 J.

2. The heavily calendered multiple component sheet according to claim 1, wherein the melting point of the lower-melting component is at least 90° C. lower than the melting point of the higher-melting component.

3. The heavily calendered multiple component sheet according to claim 2, wherein the multiple component filaments are bicomponent sheath-core filaments and the sheath comprises the lower-melting component.

4. The heavily calendered multiple component sheet according to claim 3, wherein the sheath comprises a polyolefin and the core comprises a polymer selected from the group consisting of polyesters and polyamides.

5. The heavily calendered multiple component sheet according to claim 4, wherein the sheath comprises a polymer selected from the group consisting of polyethylene and polypropylene, and the core comprises a polymer selected from the group consisting of poly(ethylene terephthalate), poly(1,4-butylene terephthalate), poly(hexamethylene adipamide), and polycaprolactam.

6. The heavily calendered multiple component sheet according to claim 5, wherein the sheath comprises linear low density polyethylene and the core comprises poly(ethylene terephthalate).

7. The heavily calendered multiple component sheet according to claim 6, wherein the sheath component comprises less than about 50 weight percent of the bicomponent fibers.

8. A multi-layer laminate comprising the heavily calendered multiple component spunbond sheet of claim 1, adhered to a second sheet layer.

9. The multi-layer laminate according to claim 8, wherein the second sheet layer comprises a first barrier layer selected from the group consisting of polymeric films, metal foils, coated polymeric films, and metalized polymeric films.

10. The multi-layer laminate according to claim 9, further comprising a heat-seal layer adhered to the side of the first barrier layer opposite the heavily calendered sheet.

11. The multi-layer laminate according to claim 10, further comprising an adhesive tie layer intermediate the heavily calendered sheet and the first barrier layer.

12. The multi-layer laminate according to claim 8, wherein the second sheet layer comprises a thermoplastic polymeric barrier heat-seal layer that has been extruded onto the heavily calendered sheet.

13. A blister package comprising a blister component having an inner surface and an outer surface and a lidding component comprising the multi-layer laminate according to any of claims 10-12, the lidding component having an outer surface comprising the heavily calendered multiple component spunbond sheet and an inner surface comprising the heat seal layer, wherein selected portions of the inner surfaces of the blister and lidding components are adhered together by the heat-seal layer to form a continuous seal and at least one cavity therebetween, the blister component comprising a second barrier layer selected from the group consisting of polymeric films, coated polymeric films, metal foils, and film-foil laminates.

14. The blister package according to claim 13, wherein the seal between the heat seal layer and the blister component is peelable.

15. The blister package according to claim 13, wherein the first barrier layer is a frangible material selected from the group consisting of frangible polymeric films and metal foils.

16. A blister package comprising a blister component having an inner surface and an outer surface and a lidding component comprising the multi-layer laminate according to claim 11, the lidding component having an outer surface comprising the heavily calendered multiple component spunbond sheet and an inner surface comprising the heat seal layer, wherein selected portions of the inner surfaces of the blister and lidding components are adhered together by the heat-seal layer to form a continuous seal and at least one cavity therebetween, the blister component comprising a second barrier layer selected from the group consisting of polymeric films, coated polymeric films, metal foils, and film-foil laminates, and wherein the adhesive tie layer is a peelable layer and the first barrier layer is a frangible material selected from the group consisting of frangible polymeric films and metal foils.

17. A multi-layer laminate according to claim 8, wherein said second sheet layer comprises a second multiple component spunbond sheet and at least one layer of meltblown fibers sandwiched between the first and second multiple component spunbond sheets.

18. The multi-layer laminate according to claim 17, further comprising a barrier layer adhered to said second multiple component spunbond sheet with an adhesive tie layer, said barrier layer selected from the group consisting of polymeric films, metal foils, coated polymeric films, and metalized polymeric films.

19. The multi-layer laminate according to claim 18, further comprising a heat-seal layer adhered to the side of the barrier layer opposite the heavily calendered multiple component spunbond sheet.

20. A blister package comprising a blister component having an inner surface and an outer surface and a lidding component having an inner and outer surface, the lidding component comprising a multi-layer laminate of a spunbond/meltblown/spunbond fabric and a first barrier layer, wherein at least one of said spunbond layers is a heavily calendered multiple component spunbond sheet comprising continuous multiple component spunbond filaments, the multiple component filaments comprising between about 10 and 90 weight percent of a first lower-melting polymeric component and between about 90 and 10 weight percent of a second higher-melting polymeric component, the first polymeric component comprising at least a portion of the peripheral surface of the filaments, wherein interstitial spaces between the filaments are at least partially filled by the lower-melting component and are substantially free of separately added resin binder, said heavily calendered sheet having an Elmendorf tear measured in both the machine direction and the cross direction of between 0.5 lb and 6.0 lb, a Graves tear measured in both the machine direction and the cross direction of at least 4.0 lb, and a Spencer Puncture of at least 0.70 J, said second spunbond layer is a multicomponent spunbond sheet, said first barrier layer adhered to said second multiple component spunbond sheet, said first barrier layer is selected from the group consisting of polymeric films, metal foils, coated polymeric films, and metalized polymeric films, wherein selected portions of the inner surfaces of the blister and lidding components are adhered together to form a continuous seal and at least one cavity therebetween, the blister component comprising a second barrier layer selected from the group consisting of polymeric films, coated polymeric films, metal foils, and film-foil laminates, and wherein the outer surface of the lidding component comprises the heavily calendered multiple component sheet.
